(19) United States
(12) Patent Application Publication
(10) Pub. No.: US 2018/0218585 A1
(43) Pub. Date: Aug. 2, 2018

(54) Handling Device And Method For Operating A Handling Device

(71) Applicant: J. SCHMALZ GMBH, GLATTEN (DE)

(72) Inventors: Klaus-Dieter Schwabenthan, Balingen (DE); Jonas Mast, Baiersbronn (DE); Bernd Heinzmann, Lossburg (DE); Walter Schaaf, Freudenstadt-Gruental (DE); Aline Defranceski, Horb a.N. (DE)

(73) Assignee: J. SCHMALZ GMBH, GLATTEN (DE)

(21) Appl. No.: 15/874,029

(22) Filed: Jan. 18, 2018

(30) Foreign Application Priority Data
Jan. 18, 2017 (DE) 10 2017 100 883.7

(51) Int. Cl. G08B 21/18; B25J 1/00; B25J 9/16

(52) U.S. Cl. CPC G08B 21/18; B25J 9/1674; B25J 1/00

(57) ABSTRACT

A handling device for handling an object by means of manual control of the handling device by an operator, including a sensor apparatus and an evaluating apparatus, is designed and developed with a view to further simplify the handling of objects using a handling device such that the sensor apparatus comprises sensors for detecting the position of the handling device and movement data of the handling device in the form of measured values, such that the evaluating apparatus is designed to generate handling instructions and/or handling-related information for the operator by evaluating the detected measured values, and such that an output apparatus is provided for outputting the handling instructions and/or handling-related information to the operator.

### CROSS-REFERENCE TO RELATED APPLICATIONS

This application relates and claims priority to German Application No. DE102017100883.7 filed Jan. 18, 2017, the entire disclosure of which is incorporated herein by reference.

### BACKGROUND OF THE INVENTION

The invention relates to a handling device for handling an object by means of manual control of the handling device by an operator, comprising a sensor apparatus and an evaluating apparatus. In addition, the invention relates to a method for operating a handling device for handling an object by means of manual control by an operator.

Handling devices for handling an object and methods for operating a handling device are known from the prior art. For example, DE 10 151 883 B4 discloses a vacuum handling device, by means of which an operator can pick up and transport even heavy objects, and set them down at a destination. However, there is room for optimization. Therefore, this device does provide a lifting aid for an operator, but the operator has to coordinate the handling process alone and control the handling device. This is a burden on the operator.

### SUMMARY OF THE INVENTION

The problem addressed by the invention is to further simplify the handling of objects using a handling device, and in particular to assist an operator in a customized and application-specific manner.

The invention solves the problem by means of a handling device. The handling device is characterized in that the sensor apparatus comprises sensors for detecting the position of the handling device and movement data of the handling device in the form of measured values, in that the evaluating apparatus is designed to generate handling instructions and/or handling-related information for the operator by evaluating the detected measured values, and in that an output apparatus is provided for outputting the handling instructions and/or handling-related information to the operator.

This makes it easier to handle objects, since handling instructions and/or handling-related information relating in a customized manner to the handling operation or the operator is output which is used to assist and guide the operator in controlling the handling device. By outputting the handling instructions and/or the handling-related information, it can be ensured that an object is correctly assigned and correctly handled. The operator receives targeted information regarding a current handling process, for example the specification of a destination, a movement sequence, a handling speed or a load warning. The risk of damage due to incorrect handling or of additional work due to incorrect assignment is hereby reduced. An object can be efficiently handled in a comparatively short time. Assistance is customized, meaning that physically impaired persons can also be assisted. Owing to this assistance, the operator becomes fatigued less rapidly. In addition, the risk of accidents and damage is reduced.

The detected measured values are in particular the position in a reference system (detection of coordinates) and movement data, in particular a speed vector and an acceleration vector, of the handling device or of a portion of the handling device, for example an operating handle. The sensors of the sensor apparatus may be designed as a GPS sensor, an optical sensor (e.g. camera with image correlation), a displacement sensor (e.g. potentiometer) or an acceleration sensor. The sensors may be arranged on the handling device or on a portion of the handling device, in particular on an operating handle. The sensors may be connected to the sensor apparatus by a wireless or wired connection.

A handling operation is understood to mean picking up or grasping an object at a pick-up location, transporting the object from the pick-up location to a destination and setting down or depositing the object at the destination. The handling device may be a crane, a luggage conveyor belt, a tube lifter or another manually guided device for handling assistance.

In a preferred embodiment, the output apparatus may comprise a display element for displaying the handling instructions and/or handling-related information. Sensor values, states and/or information can thus be reliably output irrespective of any ambient noise. This can be carried out using one or more lighting apparatuses, for example using one or more LEDs or a display. It is also conceivable for light pulses to be output by the lighting apparatus.

The output apparatus is designed for outputting the handling instructions and/or handling-related information in the form of optical, acoustic and/or haptic signals. In this way, (optically, acoustically and/or haptically) appropriate signals can be output over one or more suitable channels. Important signals or warning signals can be output over several or all of the channels, in particular when the operator does not carry out a handling or confirmation step in response to a preceding signal.

The output apparatus may be arranged on the handling device, for example may be directly fastened to the handling device. As a result, handling instructions and/or handling-related information can be directly output to the handling device, such that it is ensured that said instructions or information are assigned to the handling device independently of the actual operator. Specifically, the output apparatus may be arranged on and/or fastened to lifting equipment or an operating handle of the handling device.

Alternatively or additionally, the output apparatus may be a wearable output apparatus for the operator to wear on their body. This makes it possible for signals to be reliably output to the operator, specifically also if the operator is not in the immediate vicinity of or is not in direct contact with the handling device. The wearable output apparatus may be a wristband, a smartwatch, a smartphone, headphones or an acoustic earbud (in ear). In order to output signals particularly reliably, an output apparatus comprising an output unit on the handling device and a wearable output unit for the operator to wear on their body is conceivable.

Advantageously, at least one drive apparatus for regulating the movement speed and/or reaction speed of a handling operation may be provided. The drive apparatus acts on the handling device and is designed such that the handling device can not only be driven, but can also be decelerated. As a result, a handling operation, for example transporting the object from a pick-up location to a destination, can be assisted and regulated in a highly targeted manner. For example, irregular movements by a physically impaired operator can be compensated for (“smoothed out”) or sudden movements can be decelerated (slowed down).

In a preferred embodiment, an identification apparatus can be provided which is designed to identify the operator and/or the object to be handled. Therefore, information regarding properties of an object to be handled (correct assignment, size, weight, fragility, pick-up location and/or destination) and/or of an operator (height, weight, etc.) can be obtained, processed and taken into account during the handling operation. The identification apparatus may be designed to carry out identification by means of RFID, a mobile terminal (e.g. smartphone), a QR code, barcodes, a user identifier (input of username and password into the handling device), or another code. The identification apparatus may comprise sensors, input apparatuses and/or communication elements required for this purpose.

Alternatively or additionally to sensors arranged on the handling device, the sensors of the sensor apparatus may be designed as external sensors and may be arranged in the environment surrounding the handling device, for example in a space in which the handling device is arranged. Therefore, a structurally advantageous design is achieved in which the handling device is not impaired by the sensors, either in terms of construction or in terms of weight. In addition, it is possible for the sensors to be universally used, since they can be used by a plurality of handling devices. The external sensors may be designed as light barriers, GPS sensors, acceleration sensors, proximity switches or as motion-detection apparatuses comprising at least one camera and an image-processing apparatus (e.g. computer, tablet, smartphone). In addition, the sensors can be connected to the sensor apparatus by means of a cable-free or cabled connection. In order to particularly precisely and/or redundantly detect the position and the movement data of the handling device, a combination of sensors arranged on the handling device and arranged in the environment surrounding the handling device is also conceivable.

The problem mentioned at the outset is also solved by a method for operating a handling device for handling an object by means of manual control by an operator. This method is characterized by the following steps:
detecting the position of the handling device and movement data of the handling device in the form of measured values (in particular by means of the sensor apparatus),
determining handling instructions and/or handling-related information by evaluating the detected measured values (in particular by means of the evaluating apparatus), and
outputting the handling instructions and/or handling-related information to the operator (in particular by means of the output apparatus).

With respect to the advantages achieved by the method, reference is made to the comments regarding the above-described handling device.

In a preferred embodiment, before or during the handling operation, the object to be handled and/or the operator may be identified. From this, operating parameters of the handling device (e.g. movement speeds, level of power assistance, etc.) that are adjusted to the object to be handled and/or to the operator in a customized manner can be determined, for example by the evaluating apparatus. Therefore, information regarding properties of an object to be handled (correct assignment, size, weight, fragility, pick-up location and/or destination) and/or of an operator (height, weight, etc.) can be obtained, processed and taken into account during the handling operation (operating parameters). This contributes to the correct object being able to be transported to the correct destination in the correct manner. For example, a correct layout of layers (objects) can be produced during palletizing. It can also be ensured that objects are correctly depalletized and distributed onto different belts (destination). This reduces the risk of objects being incorrectly packaged or sorted.

The identification can be carried out by means of the handling device, in particular by means of the identification apparatus of the handling device, for example by means of RFID, QR codes, barcodes or a user identifier (username and password). The operator can also carry out manual identification. Because the properties of the operator are known, the handling device can be adjusted to the operator, for example by setting the working height, grip positions or maximum values for the movement of the handling device. In addition, load thresholds to be observed can be specified. For ergonomic or health reasons, targeted power assistance can take place or special movements or accelerations can be restricted so as to be adjusted to the operator. Alternatively or additionally, this information can be displayed, for example by means of the output apparatus.

Advantageously, an optimal movement path can be output for handling the object and/or optimal operating commands can be specified. By specifying the optimal movement path, the object can be moved to the destination over the shortest path or the path that is simplest for the handling operation, for example, such that the handling operation is simplified and accelerated. The optimal movement path can for example be output, in particular to the output apparatus, by an optical direction vector. The movement path and/or the operating commands can be produced by means of the handling instructions and/or handling-related information, or on the basis of information stored in the evaluating apparatus relating to the particularly identified object. For example, for a fragile object, a handling operation having a low speed can be specified and the object can be prevented from being dropped. Likewise, a pivoting movement of the handling device can be assisted by specifying the pivot path. In this case, an adjustment to the individual situation of the operator can take place, e.g. a handling operation as a training session, for rehabilitation or prevention. By specifying optimal operating commands, the handling is made even easier, since the handling device is adjusted to the object to be handled, for example by fine-tuned actuation of valves of a suction gripper, a fine-tuned lifting speed of a tube lifter or crane, or a method for the handling device having a speed defined for the object.

Expediently, on the basis of a comparison of already detected measured values from an earlier handling operation with current measured values from another, in particular identical, handling operation, a fatigue state or overload of an operator can be determined. Alternatively or additionally, on the basis of an evaluation of the number of handling operations, a need for maintenance of the handling device can be determined. As a result, the working safety can be increased. Recorded measured values can be compared with current measured values, and if a threshold value for the operating duration or a sensor value, for example a vacuum value, is exceeded, a signal is output. It can thus be signaled to the operator that they need to take a break or switch to another handling device. Likewise, it can be signaled to the operator that another movement pattern or load profile needs to be used. A need for maintenance of the handling device can also be output in this way. Sensor values or vacuum values can determine the number of the handling operation (picking number) actuated by the handling device, and a need for maintenance can be signaled when a defined number of handling operations is exceeded.

Preferably, similar, repetitive movement profiles of the handling device can be identified and more optimal (e.g. shorter) movement paths can be proposed and/or repetitive movements can be assisted in particular predictively (e.g. covering long handling distances or regions of precision adjustment).

Advantageously, the handling device can operate in a self-learning manner (self-learning mode). This means that the handling device can respond to known individual load profiles of users and cover said profiles. For example, dragging and/or jerky movements of a physically impaired operator can be reduced or compensated for.

It is also conceivable, owing to the self-learning mode, for the handling device to be able to partially autonomously travel through movement patterns, for example returning (without the object) after depositing the object at a destination or returning to a standby position.

Advantageously, the handling device can adjust movement profiles, in particular also movement speeds, on the basis of the capacity utilization with handling processes or the time remaining for a handling process, or can propose such an adjustment, for example by optical and/or acoustic signals being output to the operator.

### BRIEF DESCRIPTION OF THE DRAWINGS

The invention is explained in greater detail in the following with reference to the drawings, in which:

FIG. 1 is a side view of an embodiment of a handling device;

FIG. 2 is a side view of an embodiment of a handling device;

FIG. 3 is a plan view of the handling device from FIG. 1;

FIG. 4 shows pressure curves on the handling device from FIG. 1 for a plurality of handling processes; and

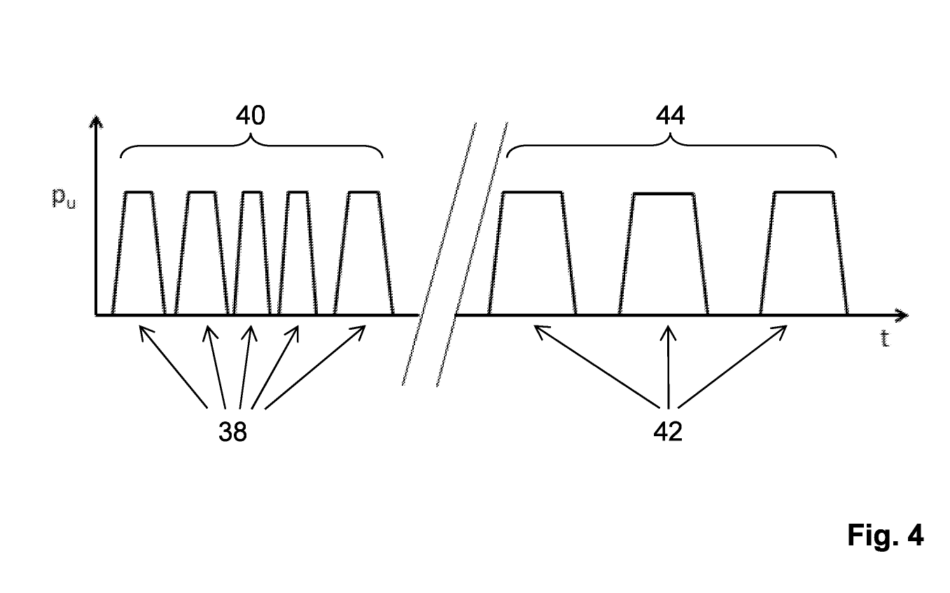

FIG. 5 shows pressure curves on the handling device from FIG. 1 for handling processes for different objects.

### DETAILED DESCRIPTION

In the following description and in the drawings, the same reference signs are used for identical or corresponding features.

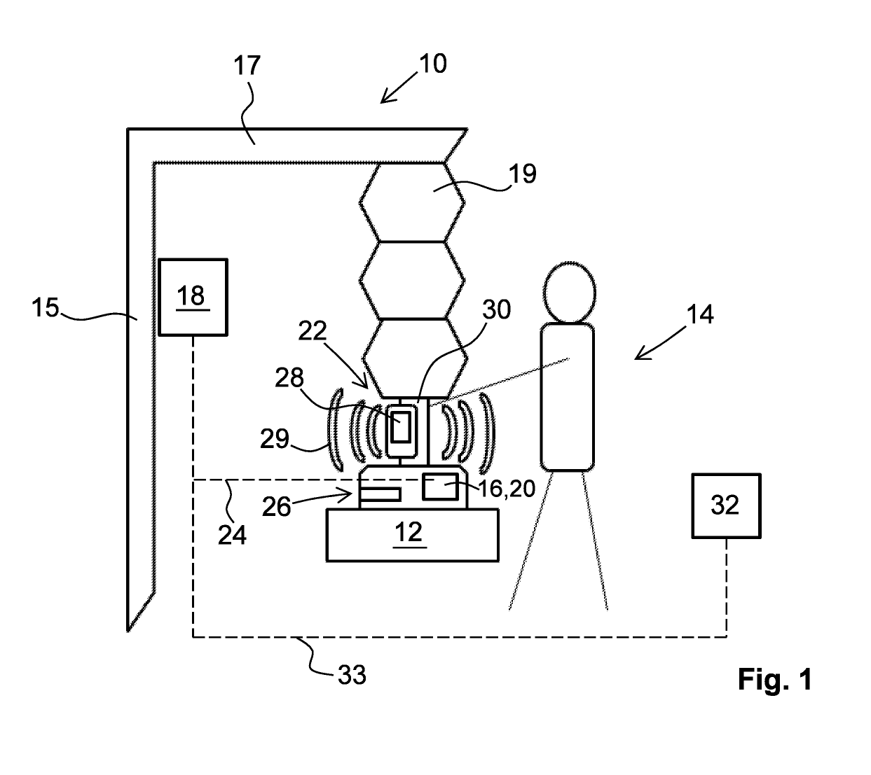

FIG. 1 shows a handling device for handling an object 12 by means of manual control of the handling device by an operator 14, the handling device as a whole being denoted by reference sign 10.

The handling device 10 comprises a sensor apparatus 16 and an evaluating apparatus 18. The sensor apparatus 16 comprises sensors 20 for detecting the position of the handling device 10 and movement data of the handling device 10 in the form of measured values.

The evaluating apparatus 18 is designed to generate handling instructions and/or handling-related information for the operator 14 by evaluating the detected measured values. In addition, an output apparatus 22 is provided for outputting the handling instructions and/or handling-related information to the operator 14.

The sensor apparatus 16 and the evaluating apparatus 18 are interconnected by means of a cable-free or cabled connection 24. The sensors 20 are arranged on the handling device 10.

The handling device 10 is designed as a tube lifter. A pivot arm 17 is fastened to a column 15, on the free end of which arm a tube 19 is arranged. A gripper or suction gripper 26 is arranged on the free end of the tube 19. The sensor apparatus 16 and the sensors 20 are arranged on the gripper 26 such that the position and movement data of the gripper 26, in particular an operating handle 30 of the gripper 26, are detected.

The output apparatus 22 comprises a display element 28 for displaying the handling instructions and/or handling-related information. The display element 28 is designed as a display. The output apparatus 22 may be designed for outputting the handling instructions and/or handling-related information in the form of optical, acoustic and/or haptic signals 29.

The output apparatus 22 is arranged on the handling device 10, specifically on the operating handle 30 of the handling device 10 (see FIG. 1).

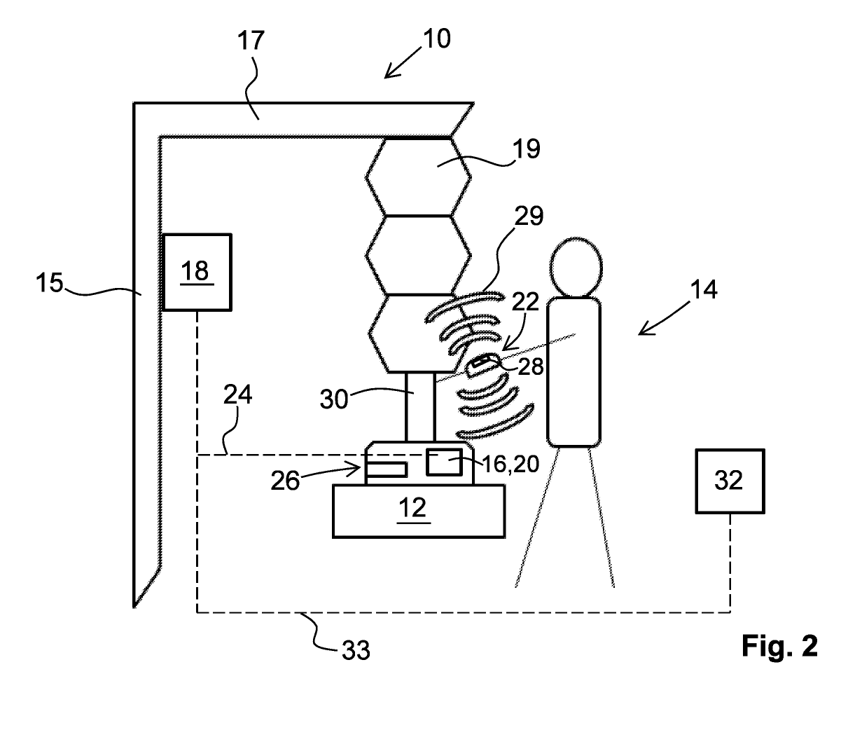

The output apparatus 22 may also be a wearable output apparatus 22 for the operator 14 to wear on their body (see FIG. 2). The output apparatus 22 is or can be fastened to the body of the operator 14.

An identification apparatus may be provided which is designed to identify the operator 14 and/or the object 12 to be handled and comprises corresponding sensors, input apparatuses and/or communication elements, as described in the general part of the description (not shown).

Alternatively or additionally, the sensors 20 may be designed as external sensors 32 and may be arranged in the environment surrounding the handling device 10. The sensors 32 are connected to the evaluating apparatus 18 by means of a cable-free or cabled connection 33.

The method for operating a handling device 10 for handling an object 12 by means of manual control by an operator 14 proceeds as follows:

First, the position of the handling device 10 and movement data of the handling device 10 are detected in the form of measured values, with the position and the movement data of the gripper 26, in particular of the operating handle 30 of the gripper 26, being detected in the present case. This can be carried out by means of the sensor apparatus 16.

Then, handling instructions and/or handling-related information are determined by evaluating the detected measured values, which can be carried out by means of the evaluating apparatus 18. Subsequently, the handling instructions and/or handling-related information are output to the operator 14, in particular by means of the output apparatus 22.

Before or during the handling of the object 12, the object 12 and/or the operator 14 can be identified, using corresponding sensors, input apparatuses and/or communication elements of the sensor apparatus 16 (not shown).

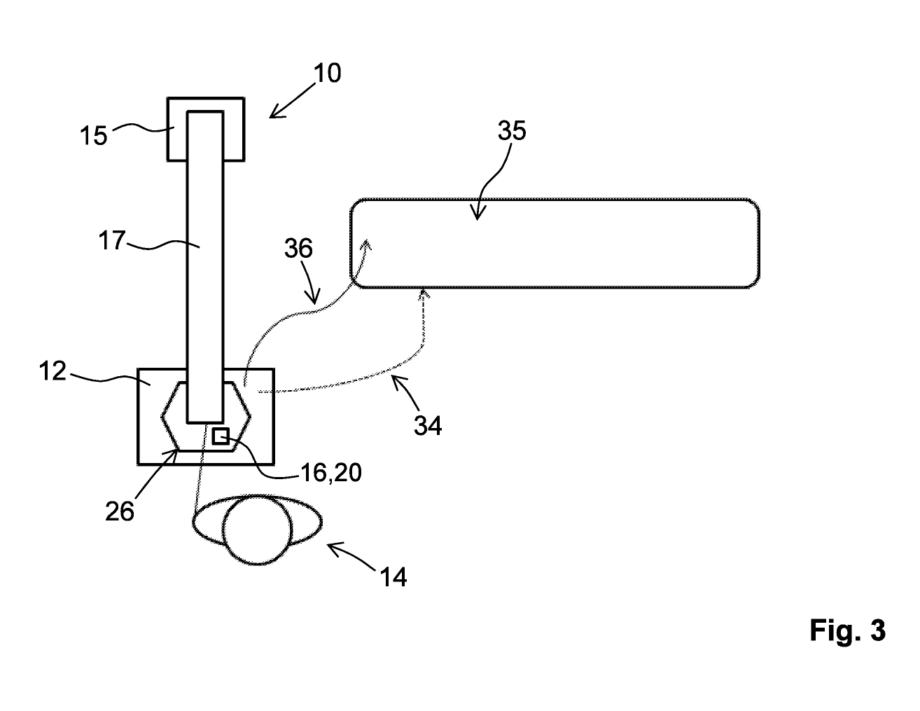

For the handling of the object 12, an optimal movement path 34 can be output for moving the object to a destination 35 (see FIG. 3), which may be a storage area. The movement path 34 can be output by means of a direction vector shown on the display element 28 of the output apparatus 22. Owing to the optimal movement path 34, a simpler handling operation is achieved in comparison with the less favorable movement path 36 intended by the operator 14.

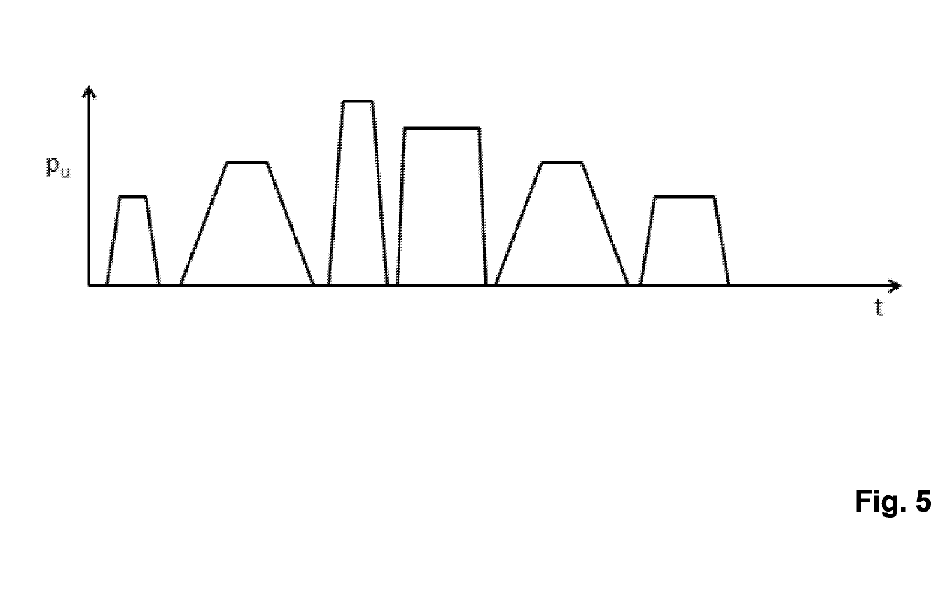

Alternatively or additionally, operating commands may be specified for the handling of the object 12. For example, the level and/or the progression of the vacuum prevailing on the gripper 26 can be adjusted to the object 12 to be handled (see FIG. 5).

The optimal movement path 34 and/or the operating commands can be determined and output by means of the handling instructions, the handling-related information and/or on the basis of information stored in the evaluating apparatus 18 relating to the identified object 12.

In addition, movement profiles that are adjusted to the operator 14 and/or the handling of the object 12 are specified.

On the basis of a comparison of detected measured values 38 at least from one earlier handling operation 40 with current measured values 42 at least from another identical handling operation 44, a fatigue state or overload state of the operator 12 can be determined. The measured values 38, 42 may be pressure values detected at the gripper 24.

For example, fatigue may be determined if a threshold value in the operating time for the handling process is exceeded and/or if break times between individual handling operations are exceeded. If a threshold value for the operating duration is exceeded during at least one handling operation, a corresponding signal can be output to the operator 14 by means of the output apparatus 22.

The number of handling operations carried out using the handling device 10 can be determined on the basis of the number of measured values 38, 42 (picking number). When a determined threshold value for the number of handling operations is exceeded, a signal can be output to the operator 14 by means of the output apparatus 22 in order to signal to the operator that the handling device 10 needs maintenance.

What is claimed is:

1. Handling device for handling an object by means of manual control of the handling device by an operator, comprising a sensor apparatus and an evaluating apparatus, characterized in that the sensor apparatus comprises sensors for detecting the position of the handling device and movement data of the handling device in the form of measured values, and in that the evaluating apparatus is designed to generate handling instructions for the operator by evaluating the detected measured values and in that an output apparatus is provided for outputting the handling instructions to the operator, the output apparatus being designed for outputting the handling instructions to the operator in the form of optical, acoustic and/or haptic signals.

2. Handling device according to claim 1, characterized in that the output apparatus comprises a display element for displaying the handling instructions.

3. Handling device according to claim 1, characterized in that the output apparatus is arranged on the handling device.

4. Handling device according to claim 1, characterized in that the output apparatus is a wearable output apparatus for the operator to wear on their body.

5. Handling device according to claim 1, characterized in that at least one drive apparatus is provided for regulating the movement speed of a handling operation.

6. Handling device according to claim 1, characterized in that an identification apparatus is provided which is designed for identifying at least one of the operator and-the object.

7. Method for operating a handling device for handling an object by means of manual control by an operator, characterized by the following steps:
detecting the position of the handling device and movement data of the handling device in the form of measured values,
determining handling instructions by evaluating the detected measured values, and
outputting the handling instructions to the operator in the form of at least one of optical, acoustic and-haptic signals.

8. Method according to claim 7, characterized in that, no later than during the handling operation, at least one of the object and the operator is identified.

9. Method according to claim 7, characterized in that a movement path is output for at least one of the handling of the object and-operating commands are specified.

10. Method according to claim 7, characterized in that movement profiles that are adjusted to at least one of the operator and the handling of the object are specified.

11. Method according to claim 7, characterized in that, on the basis of a comparison of detected measured values from an earlier handling operation with current measured values from another handling operation, at least one of:
a. at least one of a fatigue state and overload state of an operator is determined, and
b. in that, on the basis of an evaluation of the number of handling operations, a need for maintenance of the handling device is determined.
